(19) United States
(12) Patent Application Publication
(10) Pub. No.: US 2017/0348923 A1
(43) Pub. Date: Dec. 7, 2017

(54) METHOD FOR PRODUCING AN ELEMENT IN A COMPOSITE MATERIAL

(71) Applicant: DCNS, Paris (FR)

(72) Inventors: Fabien ROSSO, PLUGUFFAN (FR); Dominique LUCAS, LORIENT (FR)

(21) Appl. No.: 15/535,571

(22) PCT Filed: Dec. 15, 2015
(86) PCT No.: PCT/EP2015/079798

§ 371 Date: Jun. 13, 2017

(30) Foreign Application Priority Data
Dec. 17, 2014 (FR) 14/02891

(51) Int. Cl. B29C 70/54; B29C 70/30; B29C 70/68; B29C 33/12; B29K 105/08

(52) U.S. Cl. CPC B29C 70/545; B29C 70/68; B29C 33/123; B29C 70/30; B29K 2105/0809

(57) ABSTRACT

A disclosed manufacturing method includes a step for draping a fiber reinforcement, into a plurality of superposed layers, a step for providing resin in the fiber reinforcement, and a step for polymerizing the resin. The method includes, prior to the draping step, a step for making cutouts with a predetermined shape in the fiber reinforcement, and during the draping step, the layers of fiber reinforcement are superposed by putting the cutouts facing each other, the whole of the cutouts of the superposed layers forming a housing at least for an insert.

The present invention relates to a method for manufacturing an element in a composite material.

In the state of the art, a manufacturing method including a step for draping a fiber reinforcement, in a plurality of superposed layers is already known. The method also includes a step for providing resin in the fiber reinforcement. This step for providing resin may be prior to the draping step, notably in the case when a pre-impregnated fiber reinforcement is used, or subsequent to the draping step. The method subsequently includes a step for polymerizing the resin.

In certain cases, it is necessary to make an orifice in the manufactured composite element, for example in order to introduce therein an insert. This is notably the case within the scope of the manufacturing of tidal wave vanes, such vanes being generally attached on a composite element.

Such an orifice is generally made during a piercing step, subsequently to said polymerization step. Such a piercing step is relatively difficult to apply, notably because of problems of a technical, hardware and economical order, more particularly in the case of composite structures having a strong thickness. Indeed, the piercing of a composite element with a strong thickness requires particularly expensive specific tools. Thus, the step for piercing a composite element may represent up to 15% of the total cost of the manufacturing method for this composite element.

The object of the invention is notably to find a remedy to this drawback, by proposing a manufacturing method for an element in composite material, including at least one orifice made in a simple and economical way.

For this purpose, the object of the invention is a method for manufacturing an element in a composite material, including:
a step for draping a fiber reinforcement, in a plurality of superposed layers,
a step for providing resin in the fiber reinforcement, prior or subsequently to the draping step, and
a step for polymerizing the resin,
   characterized in that:
the method includes, prior to the draping step, a step for making cutouts with a predetermined shape in the fiber reinforcement,
during the draping step, the layers of fiber reinforcement are superposed by putting the cutouts facing each other, the whole of the cutouts of the superposed layers forming at least a housing for an insert.

The invention proposes to make cutouts in the fiber reinforcement before its draping. Such cutouts, made in a fiber reinforcement of a small thickness, are simple to make, and this without requiring any expensive tool.

During the method according to the invention, the cutouts are superposed around an insert, the presence of which gives the possibility of ensuring that the resin provided in the fiber reinforcement does not flow into the orifice made by the superposition of the cutouts.

This insert may then be extracted from the manufactured element, or be kept in this element, for example for attaching a tidal turbine vane.

It should be noted that certain layers may be without any cutout, notably when the insert is longitudinal, the important point being that the cutouts form together a housing for the insert.

A manufacturing method according to the invention may further include one or several of the following characteristics, taken alone or according to any technically conceivable combinations.
The insert includes a transverse insert having a general cylindrical shape, extending substantially perpendicularly to the layers of fiber reinforcement.
The manufacturing method includes, subsequently to the polymerization step, a step for extracting the transverse insert from its housing.
The draping step being achieved by superposing the layers of fiber reinforcement in a mould, said transverse insert is laid out in the mould before the draping step, substantially perpendicularly to the layers of the fiber reinforcement, the draping step being made by passing each cutout around the transverse insert.
The cutouts are dimensioned so as to receive the transverse insert surrounded by a pultruded tube and/or by a tubular fiber reinforcement.
The transverse insert includes a tapped orifice, extending parallel to the layers of fiber reinforcement.
The insert includes a longitudinal insert having a general cylindrical shape, notably as a threaded rod, extending parallel to the layers of fiber reinforcement.
The draping step first of all includes the superposition of a plurality of layers without any cutouts for the longitudinal insert, the draping step is continued by superposition of a plurality of layers provided with cutouts for the longitudinal insert, the method includes an intermediate step for laying out the longitudinal insert in the cutouts of the layers provided with cutouts superposed beforehand, the draping step is continued, by the superposition of the whole of the layers provided with cutouts for the longitudinal insert, these cutouts being positioned around the longitudinal insert, and the draping step is continued by the superposition of the remainder of layers without any cutout.
The draping step is made in a mould including a supporting element able to support a portion of the longitudinal insert from the intermediate layout step.
The insert includes a transverse insert provided with a tapped orifice, and a longitudinal insert assembled to the transverse insert by screwing in the tapped orifice, and:
   the draping step first of all includes the superposition of a plurality of layers without any second cutouts for the longitudinal insert, but provided with first cutouts for the transverse insert,
   the draping step is continued by the superposition of a plurality of layers provided with second cutouts for the longitudinal insert and with first cutouts for the transverse insert,
   the method includes an intermediate step for laying out the assembled longitudinal and transverse inserts, in the corresponding cutouts of the layers superposed beforehand,
   the draping step is continued by superposition of the whole of the layers provided with second cutouts for the longitudinal insert, these second cutouts being positioned around the longitudinal insert, and provided with first cutouts for the transverse insert, these first cutouts being positioned around the transverse insert,
   the draping step is continued by the superposition of the remainder of layers without any second cutouts for the longitudinal insert and provided with first cutouts for the transverse insert, these first cutouts being positioned around the transverse insert.

The invention will be better understood upon reading the description which follows, only given as an example and made with reference to the appended figures wherein:

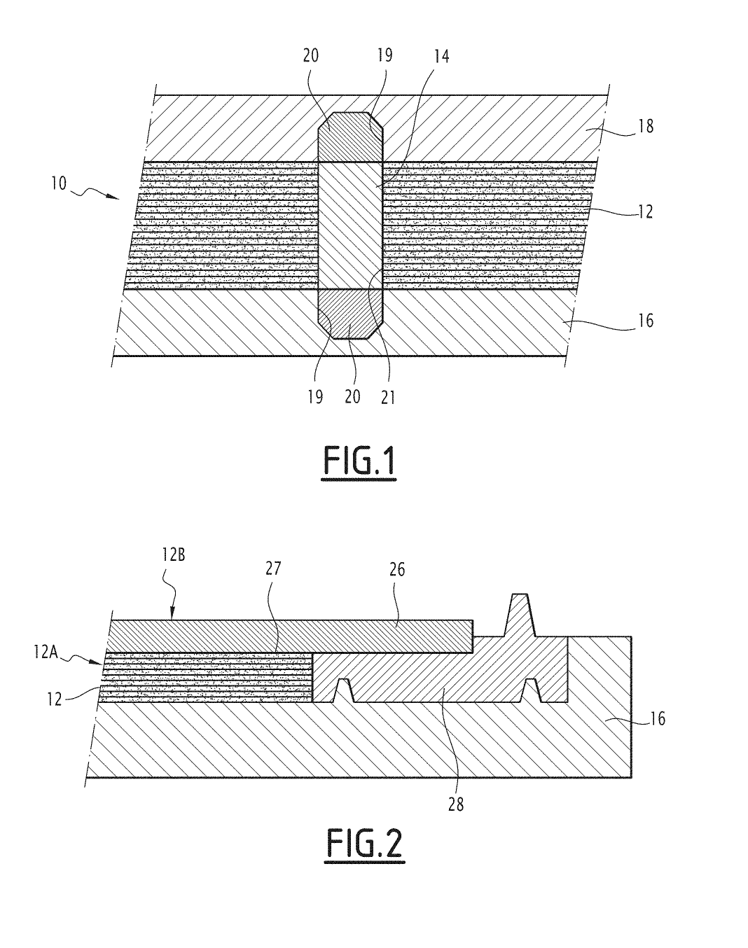

FIG. 1 is a schematic sectional view of a composite element during a step of a manufacturing method according to a first exemplary embodiment of the invention;

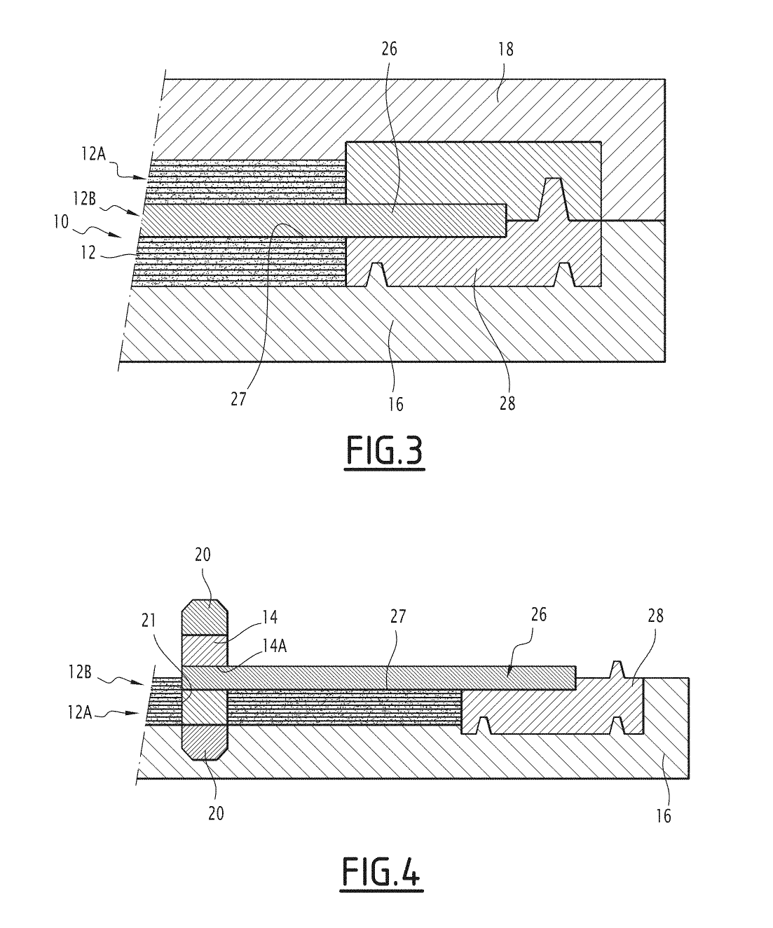

FIGS. 2 and 3 are schematic sectional views of a composite element during two distinct steps of a method according to a second exemplary embodiment of the invention;

FIGS. 4 and 5 are views similar to FIGS. 2 and 3 of a composite element during two distinct steps of a method according to a third exemplary embodiment of the invention;

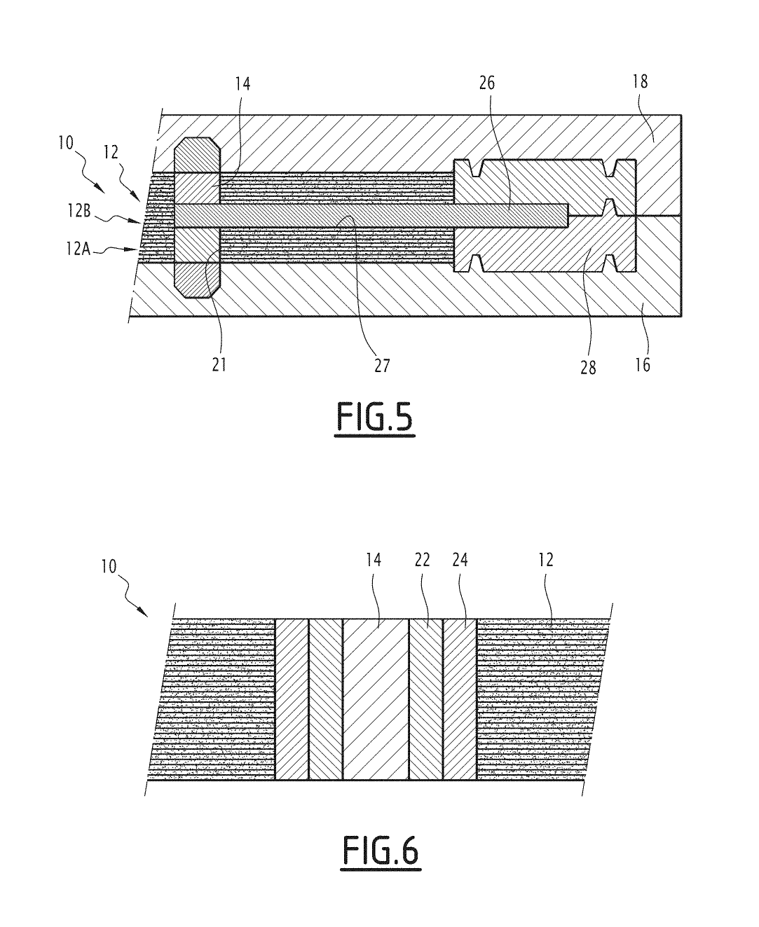

FIG. 6 is a sectional view of a composite element made according to an alternative of the first exemplary embodiment.

In FIG. 1, an element 10 in composite material is illustrated during a step of a manufacturing method according to a first exemplary embodiment of the invention.

The composite element 10 includes a reinforcement, formed by a stack of a plurality of layers of a fiber reinforcement 12, for example a reinforcement fabric 12, intended to be bound with a resin in a conventional way.

A transverse insert 14 crosses the fiber reinforcement 12, perpendicularly to said layers. For example, the transverse insert 14 has a general cylindrical shape with a substantially circular section, extending perpendicularly to the layers of the fiber reinforcement 12.

The composite element 10 is illustrated in a mould comprising a lower mould portion 16 and an upper mould portion 18.

Said mould is of a conventional type, except for the fact that it includes preferably in each of its lower 16 and upper 18 mould portions, a location 19 for a respective pin 20 for centering the insert 14.

Each centering pin 20 is secured to an end of the insert 14, for example by screwing, and housed in the respective one of the locations 19 in order to allow maintaining the transverse insert 14 in position.

The composite element 10 is manufactured during a manufacturing method which will now be described.

The manufacturing method first of all includes a step for making first cutouts of a predetermined shape in the fiber reinforcement 12. In the case of the element 10 of FIG. 1, each first cutout has a shape corresponding to the section of the transverse insert 14. Thus, in the illustrated example, each first cutout has a circular shape, with a diameter for example slightly greater than the diameter of the transverse insert 14, or alternatively slightly smaller, depending on the elasticity of the fiber reinforcement and on the desired fiber density around the insert.

The method then includes a step for draping the fiber reinforcement 12, in order to form a plurality of superposed layers. The draping is for example achieved in a conventional way, by folding the fiber reinforcement 12 on the lower portion of the mould 16.

This draping step is achieved so that each layer of fiber reinforcement has a first cutout, the first cutouts of the different layers being superposed facing each other so as to form together a first housing 21 for the transverse insert 14.

It should be noted that the transverse insert 14 is advantageously positioned on the lower mould portion 16 prior to the draping step, by positioning one of the centering pins 20 in the corresponding location 19, the other pin 20 being also mounted on the insert 14. In this case, the draping step is achieved by passing each first cutout around the transverse insert 14. Both centering pins 20 are secured with the insert 14 during the period for draping and moulding the part, and then detached upon removal from the mould.

At the end of the draping step, the mould is closed again by adding the upper mould portion 18 above the draped fiber reinforcement 12, by introducing said other centering pin 20 into the corresponding location 19 made in this upper mould portion 18.

The method then includes, in a conventional way, a step for providing resin in the fiber reinforcement 12, for example by infusion. Because of the presence of the transverse insert 14, the resin does not flow into the first housing 21 defined by the first cutouts. Alternatively, the step for providing resin is prior to the draping step. This is notably the case when the fiber reinforcement 12 is pre-impregnated.

The method then includes a conventional step for polymerizing the resin.

The thereby made composite element is then extracted from the mould, and the centering pins 20 are unscrewed from the insert 14.

The transverse insert 14 may then be extracted from its housing 21 during an extraction step. A composite element 10 is thereby obtained, including a through-orifice having the same dimensions as the insert 14.

Alternatively, the transverse insert 14 may be kept in the composite element 10.

According to an alternative, illustrated in FIG. 6, the first cutouts are dimensioned for receiving the transverse insert 14 surrounded by a pultruded tube 22 and/or by a tubular fiber reinforcement 24. In this case, after extraction of the insert 14, the through-orifice is consolidated with this pultruded tube and/or this tubular fiber reinforcement.

In FIGS. 2 and 3, a composite element during a manufacturing method according to a second exemplary embodiment of the invention has been illustrated. In these figures, elements similar to those of the preceding figure are designated with identical references.

According to this second embodiment, the insert is a longitudinal insert 26, having a general cylindrical shape, notably with a circular section. The longitudinal insert 26 is for example formed with a threaded rod. This longitudinal insert 26 extends parallel to the layers of fiber reinforcement 12.

Thus, the step for making the cutouts includes the making of second longitudinal cutouts in the fiber reinforcement 12, these second longitudinal cutouts having widths increasing from layer to the other so that the superposition of these second cutouts forms a second housing 27 with a shape mating that of the longitudinal insert 26.

The draping step first of all includes the superposition of a plurality of layers 12A of fiber reinforcement 12 without any second cutouts for the longitudinal insert 26.

The draping step then includes the superposition of a plurality of layers 12B provided with second cutouts for the longitudinal insert 26, as this is illustrated in FIG. 2. The second cutouts are superposed facing each other, their width increasing, so as to form a first half of a second housing 27 for receiving the longitudinal insert 26.

At this stage, the thickness of the superposed layers 12A, 12B substantially corresponds to half of the total thickness of the composite element 10 to be manufactured.

The method then includes an intermediate step for laying out the longitudinal insert 26 in said first half of the housing 27.

Usually, the longitudinal insert 26 is intended to extend beyond the composite element 10. Thus, this longitudinal insert 26 is only partly housed in the second housing 27 formed by the second cutouts.

For this purpose, the mould advantageously includes an element 28 for supporting the portion of the longitudinal insert 26 which extends beyond the composite element 10, allowing maintaining of the longitudinal insert 26 in position.

Following this intermediate step for laying out the longitudinal insert 26, the draping step is continued, by superposing the whole of the layers 12B provided with second longitudinal cutouts, these second cutouts being positioned around the longitudinal insert 26 until the second housing 27 is again closed.

The draping step is continued by superposition of the remainder of layers 12A without any second cutouts.

The method then includes, in the same way as earlier, a step for providing resin in the fiber reinforcement and a step for polymerizing this resin. As earlier, alternatively, the fiber reinforcement is pre-impregnated.

The composite element 10 may then be extracted from the mould. It will be noted that in the case when the longitudinal insert 26 is threaded, this longitudinal insert 26 is maintained longitudinally in the resin. Alternatively, the longitudinal insert 26 may be extracted from its housing 27.

In FIGS. 4 and 5 a manufacturing method according to a third exemplary embodiment of the invention has been illustrated. In these figures, the elements similar to those of the preceding figures are designated with identical references.

According to this third embodiment, the insert includes both a transverse insert 14, provided with a tapped orifice 14A, and a longitudinal insert 26 forming a threaded rod, assembled with the transverse insert 14 by screwing into the tapped orifice 14A.

In this case, the fiber reinforcement 12 includes both first cutouts intended to receive the transverse insert 14, and second longitudinal cutouts intended to receive the longitudinal insert 26.

Moreover, the mould is both provided with locations 19 for receiving the centering pins 20 secured to the transverse insert 14, and a supporting element 28 for the longitudinal insert 26.

In this case, the draping step first of all includes the superposition of a plurality of layers 12A without any second longitudinal cutouts but provided with first cutouts for the transverse insert 14.

This draping step is continued by the superposition of a plurality of layers 12B provided with second cutouts for the longitudinal insert 26 and with first cutouts for the transverse insert 14.

The method then includes an intermediate step for laying out the assembled longitudinal 26 and transverse 14 inserts, in the corresponding first or second cutouts of the layers 12A, 12B superposed beforehand.

The draping step is then continued, by the superposition of the whole of the layers 12B provided with second cutouts for the longitudinal insert 26, these second cutouts being positioned around the longitudinal insert 26, and provided with first cutouts for the transverse insert 14, these first cutouts being positioned around this transverse insert 14.

The draping step is continued by the superposition of the remainder of layers 12A without any second cutouts for the longitudinal insert 26 and provided with first cutouts for the transverse insert 14, these first cutouts being positioned around the transverse insert 14, as this is illustrated in FIG. 5.

The method then includes, in the same way as earlier, a step for providing resin in the fiber reinforcement 12 and a step for polymerizing the resin.

The composite element 10 is then extracted from the mould. The centering pins 20 are unscrewed from the transverse insert 14.

The insert formed by the transverse insert 14 assembled to the longitudinal insert 26 is maintained in the composite element 10. More particularly, the transverse insert 14 is maintained transversely by the longitudinal insert 26, and the longitudinal insert 26 is maintained longitudinally by the transverse insert 14.

The longitudinal insert 26 may then be used for attaching a tidal turbine vane, this vane being secured both transversely and longitudinally by the inserts 14, 26, with the composite element 10.

It will be noted that the invention is not limited to the embodiment described earlier, but may have diverse alternatives.

1-10. (canceled)

11. A manufacturing method for manufacturing an element in a composite material, including:
draping a fiber reinforcement, in a plurality of superposed layers,
providing a resin in the fiber reinforcement, prior or subsequently to the draping step, and
polymerizing the resin,
wherein:
the method includes, prior to the draping, making cutouts of a predetermined shape in the fiber reinforcement,
during the draping, the layers of fiber reinforcement are superposed by putting the cutouts facing each other, the whole of the cutouts of the superposed layers forming a housing at least for an insert.

12. The manufacturing method according to claim 11, wherein the insert includes a transverse insert having a general cylindrical shape, extending perpendicularly to the layers of fiber reinforcement.

13. The manufacturing method according to claim 12, including, following the polymerization, extracting the transverse insert from its housing.

14. The manufacturing method according to claim 12, wherein, the draping being achieved by superposing the layers of fiber reinforcement in a mould, said transverse insert is laid out in the mould prior to the draping, perpendicularly to the layers of fiber reinforcement, the draping being achieved by having each cutout pass around the transverse insert.

15. The manufacturing method according to claim 12, wherein the cutouts are dimensioned for receiving the transverse insert surrounded by a pultruded tube and/or a tubular fiber reinforcement.

16. The manufacturing method according to claim 12, wherein the transverse insert includes a tapped orifice, extending parallel to the layers of fiber reinforcement.

17. The manufacturing method according to claim 11, wherein the insert includes a longitudinal insert having a general cylindrical shape, extending parallel to the layers of fiber reinforcement.

18. The manufacturing method according to claim 17, wherein:
the draping first of all includes the superposition of a plurality of layers without any cutouts for the longitudinal insert,
the draping is continued by the superposition of a plurality of layers provided with cutouts for the longitudinal insert,
the method includes laying out the longitudinal insert in the cutouts of the layers provided with cutouts superposed beforehand,
the draping is continued, by the superposition of the whole of the layers provided with cutouts for the longitudinal insert, these cutouts being positioned around the longitudinal insert,
the draping is continued by the superposition of the remainder of layers without any cutouts.

19. The manufacturing method according to claim 18, wherein the draping is achieved in a mould including a supporting element able to support a portion of the longitudinal insert.

20. The manufacturing method according to claim 16, wherein the insert includes:
a longitudinal insert having a general cylindrical shape, extending parallel to the layers of fiber reinforcement, and
a transverse insert provided with a tapped orifice, the longitudinal insert being assembled to the transverse insert by screwing into the tapped orifice,
and wherein:
the draping first of all includes the superposition of a plurality of layers without any second cutouts for the longitudinal insert, but provided with first cutouts for the transverse insert,
the draping is continued by the superposition of a plurality of layers provided with second cutouts for the longitudinal insert and with first cutouts for the transverse insert,
the method includes laying out the assembled longitudinal and transverse inserts, into the corresponding cutouts of the layers superposed beforehand,
the draping is continued by the superposition of the whole of the layers provided with second cutouts for the longitudinal insert, these second cutouts being positioned around the longitudinal insert, and provided with first cutouts for the transverse insert, these first cutouts being positioned around the transverse insert,
the draping is continued by the superposition of the remainder of layers without any second cutouts for the longitudinal insert and provided with first cutouts for the transverse insert, these first cutouts being positioned around the transverse insert.
